(19) United States
(12) Patent Application Publication
(10) Pub. No.: US 2014/0301773 A1
(43) Pub. Date: Oct. 9, 2014

(54) Coupling for Furniture Components

(71) Applicants: Mario Di Filippo, Caerano di San Marco (IT); Paolo Zanotto, San Zenone degli Ezzelini (IT)

(72) Inventors: Mario Di Filippo, Caerano di San Marco (IT); Paolo Zanotto, San Zenone degli Ezzelini (IT)

(73) Assignee: METALMECCANICA ALBA S.R.L., San Zenone degli Ezzelini (IT)

(21) Appl. No.: 14/197,730

(22) Filed: Mar. 5, 2014

(30) Foreign Application Priority Data
Apr. 5, 2013 (IT) VE2013A000011

(51) Int. Cl. F16B 12/42

(52) U.S. Cl. CPC F16B 12/42
USPC 403/174

(57) ABSTRACT

A coupling for furniture components includes two cheeks, each including a plurality of seats which, when matched, define housings for tubular elements such as furniture legs to be secured between the two cheeks. Each seat opens at the edge of the respective cheek and has a cross-section defining, with a facing seat, a housing with a cross-section that is slightly less than that of the tubular element to be secured. In one embodiment, a flat longitudinal wall in the seat blocks the rotation of the tubular element within the housing. Each seat in at least one cheek is also provided with a projecting element cooperating with a complementary aperture defined in the tubular element, and in one embodiment has an arched portion extending from the seat towards the facing cheek to define a closed cross-section that engages the tubular element.

### FIELD OF THE INVENTION

The present invention relates to an improved coupling for furniture components.

### BACKGROUND OF THE INVENTION

Various types of couplings are known for fixing together the various constituent parts of a furniture component. These are used for example for fixing the top of a table or the seating portion of a chair to the four support legs, or for fixing the body of several chairs to a horizontal bar, or to fix together the sides of two adjacent shelving units. These traditional couplings generally consist normally of a block to which the various parts to be fixed together are welded.

However the use of welding makes these couplings of poor appearance, and moreover makes it particularly difficult to release the bond defined by them. The fact that the coupling has to be welded to the other parts of the furniture component means that this latter has to be transported in its assembled condition, with consequent high space requirement in the steps preceding its use.

In contrast, those couplings of known type to be assembled directly by the final user are difficult to mount and often require specific expertise and/or particular tools, with which the final user is not always provided.

U.S. Pat. No. 2,815,801 relates to a chair coupling consisting of two parts to be screwed together.

### SUMMARY OF THE INVENTION

An object of the invention is to eliminate all these drawbacks by providing an improved coupling, which is demountable, of pleasant appearance and easy to assemble, even by a non-expert user.

Another object of the invention is to provide an improved coupling which enables a stable and robust connection between the various parts of the furniture component.

Another object of the invention is to provide an improved coupling which also acts as a temporary stabilizing element for use during the steps involved in mounting the furniture component.

Another object of the invention is to provide an improved coupling which is extremely versatile in use and is obtainable easily, quickly and at low production cost.

These and other objects which will be apparent from the ensuing description are achieved according to the invention by an improved coupling for furniture components having features as described hereinafter.

### BRIEF DESCRIPTION OF THE DRAWINGS

Some preferred embodiments of the present invention are further clarified hereinafter by way of non-limiting example with reference to the accompanying drawings, in which:

FIG. 1 is a perspective view of a chair using the improved coupling according to the invention,

FIG. 2 is an exploded perspective view of the coupling from below,

FIG. 3 is an exploded perspective view of the coupling from above,

FIG. 4 is a lateral view of a chair using a different embodiment of the improved coupling according to the invention,

FIG. 5 is a perspective view of the coupling in the assembled configuration,

FIG. 6 is an exploded perspective view thereof from below,

FIG. 7 is an exploded perspective view thereof from above.

### DETAILED DESCRIPTION OF EMBODIMENTS OF THE INVENTION

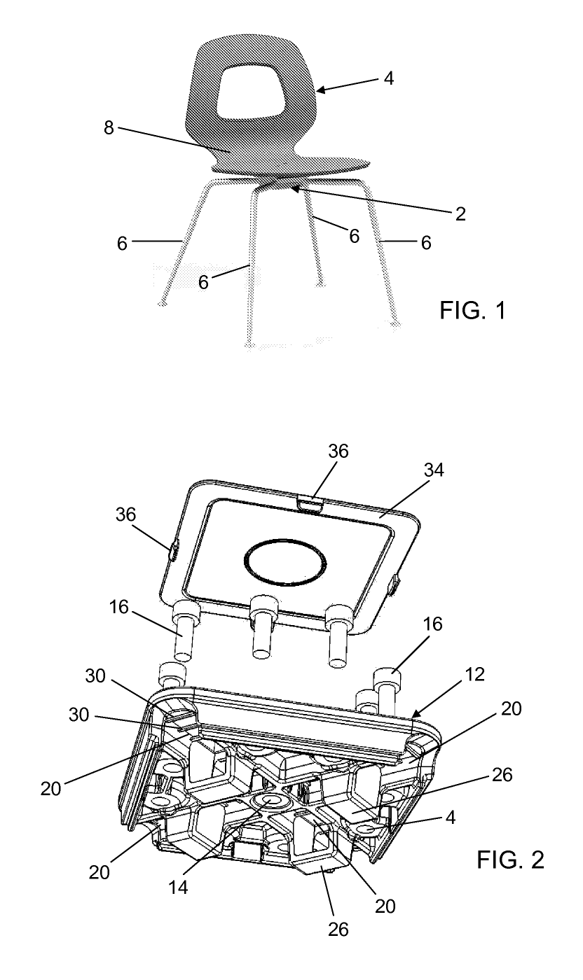

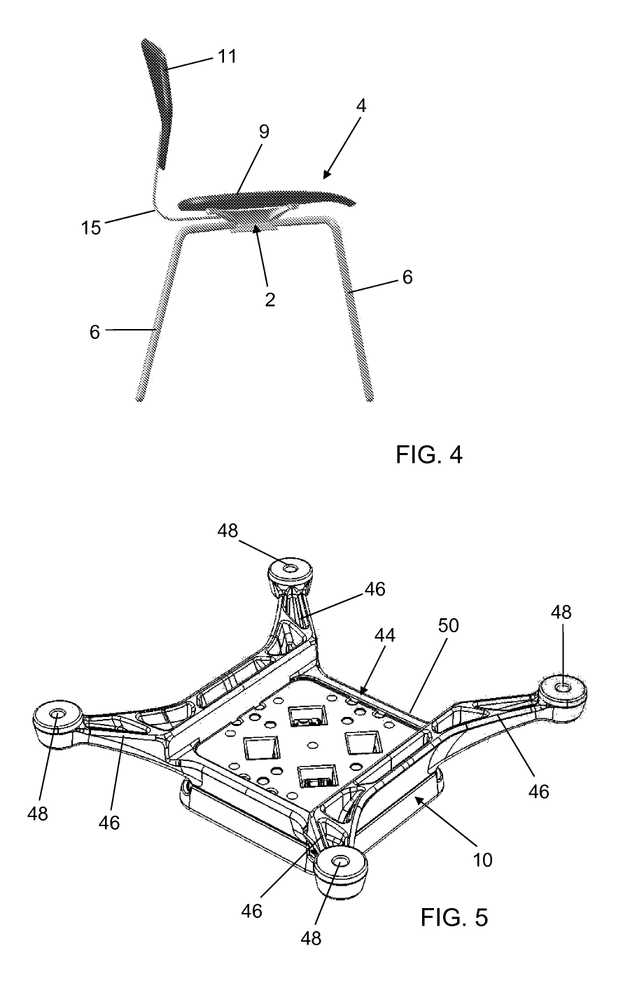

As can be seen from FIGS. 1 and 4, the improved coupling 2 according to the invention, which is generally applicable to various furniture components (chairs, bench seats, tables, shelving, etc.), is described herein in its particular use in a chair 4, to fix together the four legs 6 and to connect them to a one-piece body 8, comprising a seating portion and a back-rest (see FIG. 1), or to just the seating portion 9; more particularly, in this latter case (see FIG. 4), the back-rest 11 of the chair 4 is constructed separately from the seating portion 9 and is fixed thereto by a bracket 15 retained between the coupling 2 and the seating portion itself. When circumstances require it, one and the same furniture component can incorporate a plurality of couplings 2 according to the invention.

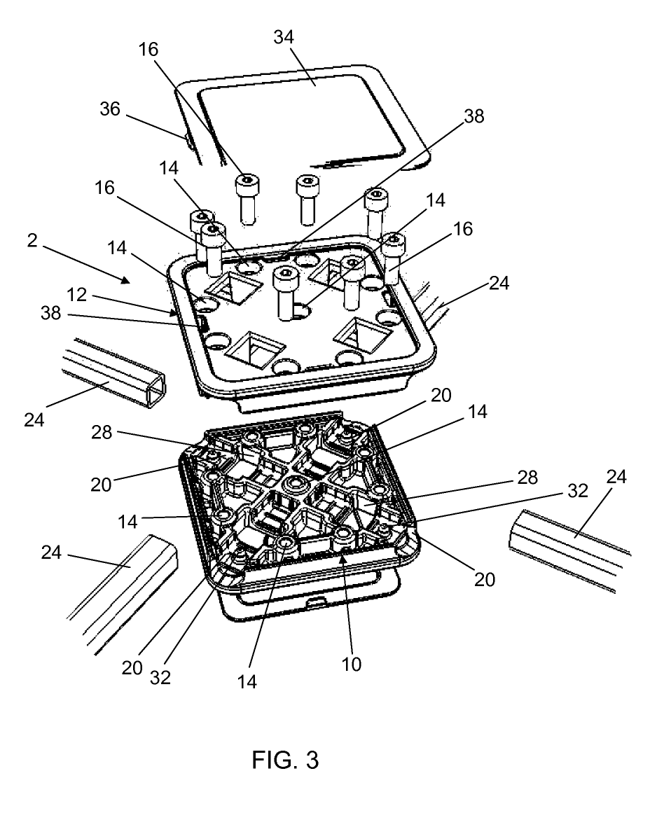

With reference to FIGS. 2 and 3, the improved coupling 2 comprises two cheeks, a lower 10 and an upper 12, which can be connected together; in particular, each cheek 10, 12 consists substantially of a plate, from the overall surface of which there perpendicularly extend a plurality of relief portions defining a series of recesses.

The cheeks 10, 12 can be made of plastic material or of metal, for example aluminum.

In the embodiment shown here, the plates 10, 12 are square, however they can also be of polygonal, oval, elliptical or irregular shape.

The connection between the two cheeks 10, 12 is preferably obtained by screws 16, which can traverse through holes 14 provided in one of the two cheeks 12 and engage in threaded seats provided in the other cheek, or can traverse through holes provided in both the cheeks 10, 12 and engage in nuts housed in suitable seats provided in the cheek opposite that into which the screws are inserted. In this latter case, the clamping screws 16 can have a length greater than the overall thickness of the two cheeks 10, 12 when coupled together, such as to emerge beyond the outer surface of that cheek opposite that into which the screws are inserted, to also constitute fixing means or members for other parts of the furniture component.

In the inner surface of both the cheeks 10, 12 depressed seats 20 are defined at 90° apart and open at the edges of said cheeks; preferably said seats 20 extend from the center of the cheeks 10, 12 and open on their outer edge.

By coupling together the inner surfaces of the two cheeks 10, 12, housings are defined in the seats 20 for tubular elements 24 to be locked therein. In particular, the housing defined in this manner is of substantially square cross-section with dimensions slightly less than those of the tubular profile 24 such as to enable the profile 24 to be clamped in the seat 20 when the cheeks 10, 12 are coupled together.

The upper cheek 12 is also provided with an arched portion 26 which extends downwards between the lateral walls of each seat 20; this is particularly advantageous during the assembly for example of a chair, in that after their insertion into the seats 20 the tubular profiles 24, which constitute the legs of the chair, remain stably attached to the cheek 12, even before its secure fixing to the other cheek 10, by virtue of the clamping effect which the arched portions 26 are able to exert on said legs. Preferably, each portion 26 defines with the respective seat 20 a substantially square cross-section, which clamps the tubular profile 24, preventing it from rotating within the respective housing.

The seats 20 of the lower cheek 10 are suitably provided with recesses 28 to receive the corresponding arched portion 26 defined in the upper cheek 12, when the two cheeks 10, 12 are coupled together.

Advantageously, on the bottom of the seats 20 a series of transverse projections 30 are defined which, when the two cheeks 10, 12 are coupled together, retain the four tubular elements 24 by adhering thereto and deform plastically to improve the effectiveness of the connection.

On the bottom of the seats 20 there are also provided projecting pins 32 intended to cooperate with corresponding holes or apertures provided in the tubular profiles 24 to block axial movement of these latter along the seats 20. The pins 32 can be of cylindrical shape or preferably slightly frusto-conical to enable a certain initial play during the positioning of the profile 24 within the seats 20, and to eliminate it completely when assembly is complete.

Covers 34 are also provided, comprising tabs 36 which snap into slots 38 defined along the sides of the outer surface of the cheeks 10, 12. The presence of these covers 34 enables the screws 16 and/or apertures present on the outer surface of the cheeks to be completely covered.

Advantageously, the edges of the upper cheek 12 are shaped with a longitudinal step for a more stable and precise fit with the edges of the lower cheek 10, which are shaped with a complementary step.

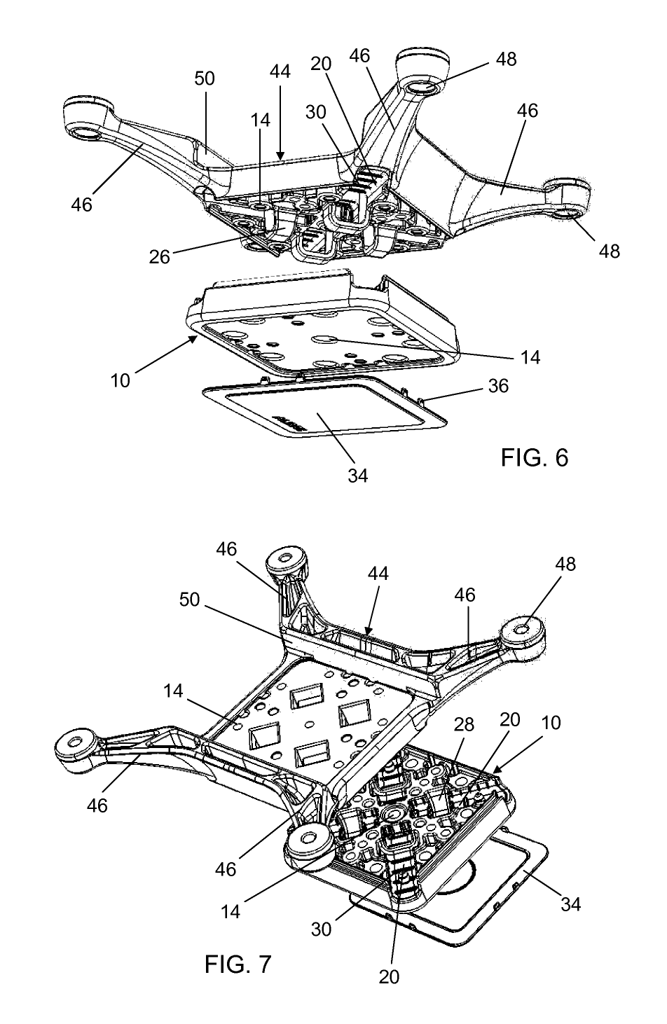

In the embodiment shown in FIGS. 4 to 7, the lower cheek 10 is identical to that of the previously described embodiment, whereas the upper cheek 44 besides presenting all the aforesaid described characteristics of the upper cheek 12, also comprises four arms 46, which extend radially outwards at 90° apart. In particular, each arm 46 has a tapered profile and is provided at its free end with an aperture 48 intended to be traversed by a screw, not shown, to secure the cheek 44 to a surface, such as the surface of a table or the seating portion 9 of a chair 4 or the side of a shelving unit.

As can be seen in FIG. 4, the two pairs of arms 46 are fixed to the seating portion 9 of the chair 4 and, advantageously, between them a space 50 is left to house the bracket 15 supporting the back-rest 11, which is secured to the seating portion 9 by said bracket.

From the aforegoing it is apparent that the improved coupling according to the invention presents numerous advantages and in particular:

it can be mounted and demounted easily and quickly, even by the user, without requiring particular equipment,

it does not use welding and is of pleasant appearance,

it is easy and quick to produce as it requires only particularly simple mechanical operations which can be implemented on automated production lines,

it can be used to assemble parts of furniture components which are considerably different from each other,

it can be used as a support to retain a part of the furniture component to be assembled while the component is being mounted.

Two preferred embodiments of the present invention have been described. However, executive variants can be made thereto in practice, without leaving the scope of protection of the present industrial patent.

The invention claimed is:

1. A coupling for furniture components comprising:
a first and a second cheeks configured to be fitted and be connected together by clamping members, wherein:
each of the first and second cheeks comprises a plurality of seats, each seat of the first cheek defining, with a seat of the second cheek, a housing configured to secure a tubular element therein,
each seat opens at an edge of the first or the second cheek, has a cross-section defining, with a corresponding seat of a facing cheek, a housing of cross-section slightly less than a cross-section of the tubular element to be secured, and is provided with a flat longitudinal wall configured to block a rotation of the tubular element within the housing,
each seat defined in at least one of the first or second cheeks is provided with a projecting element cooperating with a complementary aperture provided in the tubular element to be disposed in the seat, and
each seat defined in at least one of the first or the second cheek has an arched portion which extends from the seat towards the facing cheek to obstruct a cross-section to be engaged by the tubular element.

2. The coupling as claimed in claim 1, wherein each of the first and second cheeks comprises four seats disposed 90° apart and extending from a central zone of the cheek to an outer edge thereof.

3. The coupling as claimed in claim 1, wherein the first and second cheeks are of polygonal shape.

4. The coupling as claimed in claim 1, wherein of the first and second cheeks are made from aluminum.

5. The coupling as claimed in claim 1, wherein at least one of the first or the second cheek is provided with arms, which extend outwardly of the cheek and are configured to be fixed to a flat surface of a furniture component.

6. The coupling as claimed in claim 5, wherein said cheek is provided with two pairs of arms, between which a space is defined dimensioned to be occupied by a part of the furniture component during assembly.

7. The coupling as claimed in claim 1, wherein the clamping members emerge beyond an outer surface of one of the first and second cheeks after insertion therein, thereby defining a fixing system for other parts of a furniture component.

8. The coupling as claimed in claim 1, wherein each of the first and second cheeks is provided with a cover plate that is snap-fixable to an outer surface of the cheek.

9. The coupling as claimed in claim 1, wherein each seat of at least one of the first or second cheeks has an inner surface provided with at least one projection configured to adhere by deformation to the said tubular element when the first and second cheeks are securely connected together and retain the tubular element.

10. The coupling as claimed in claim 1, wherein each seat of a cheek comprises a recess configured, when the of the first and second cheeks are coupled together, to at least partially receive an arched portion which extends from an opposite seat of the facing cheek.

11. The coupling as claimed in claim 1, wherein each of the first and second cheeks has edges provided with a step configured to engage a complementary step provided in an edge of the facing cheek.

12. The coupling as claimed in claim 1, wherein the housing defined by facing seats in the coupled first and second cheeks is of substantially square cross-section.
